(19) United States
(12) Patent Application Publication
(10) Pub. No.: US 2020/0180802 A1
(43) Pub. Date: Jun. 11, 2020

(54) METHOD, SYSTEM, AND APPARATUS FOR BAG FORMING AND LABEL APPLICATION

(71) Applicant: AVERY DENNISON RETAIL INFORMATION SERVICES LLC, Mentor, OH (US)

(72) Inventor: Md Shafiul Alam Chowdhury, Dhaka (BD)

(21) Appl. No.: 16/707,630

(22) Filed: Dec. 9, 2019

Related U.S. Application Data
(60) Provisional application No. 62/777,232, filed on Dec. 9, 2018.

(51) Int. Cl. B65B 43/04; B65B 41/12; B65B 61/06; B65C 9/46; B65C 9/26

(52) U.S. Cl. CPC B65B 43/04; B65B 41/12; B65C 2009/0003; B65C 9/46; B65C 9/26; B65B 61/06

(57) ABSTRACT

A system and method for labeling empty transit bags may include applying labels on bag-forming material in a roll form and then sealing and cutting the bag forming material to form individual bags. The size of the bags can be varied to provide a better fit for goods that are subsequently inserted into the bags. Labeling may be done by pre-printed labels provided in a roll stock, or may be blank labels provided in a roll stock that are printed by a printer of the system. Labeling bags when they are initially formed eliminates the need to manually label bags when they are filled with goods.

### CROSS REFERENCE TO RELATED APPLICATION

The present application claims priority from U.S. Provisional Application No. 62/777,232 filed Dec. 9, 2018, which is incorporated by herein by reference in its entirety.

### FIELD OF THE INVENTION

The present invention is generally directed to formation and labeling of bags. More particularly, the invention is directed to a method and system for labeling garment transit bags during formation of said bags.

### BACKGROUND

Currently bags used for the housing and transit of garments are formed with a standard procedure. A “one size” bag is made at a first location, out of a polyethylene material, commonly referred to as a poly bag material. These bags are transported to a second location and opened. The opened bags are then put on a sewing line and filled with appropriate garments. After the garments are put into the “transit bags”, the transit bags are then sealed and shipped to appropriate locations.

However, as part of the above process, it is critical to label the transit bags with appropriate labels that can convey necessary or desired information, including contents, manufacturing date and location, shipping destination, distributor information, and the like. However, the transit bags must currently be manually labelled prior to being put on the sewing line. This creates additional labor, increased time in producing the ultimate transit bag for shipping, and can have a potentially increased rate of error. Further, in traditional methods it is time consuming to change the size of the bags for different applications, thus leading to larger than necessary transit bags being used, which increases shipping weight and provides undesirable visual appeal to the packaging and bags.

### SUMMARY

To resolve the above issues, a method, system, and apparatus for forming a transit bag and labelling the bag may be shown and described. The bag may be formed with an automated process whereby appropriate labels are affixed to the bags during the process of forming the bags. Then the bags may be completed and filled with appropriate items for shipping. Such a method, system, and apparatus can make the formation and utilization of bags more efficient, eliminate waste, enhance visual appeal, and reducing shipping weight, among other advantages.

According to some embodiments, a system for forming bags, comprises a roll feed of bag-forming material a label applicator a sealing mechanism, and a cutting mechanism. With this system, the bag-forming material may be fed to the label applicator, which may apply a label to the bag-forming material, the bag-forming material then may be fed to the sealing mechanism, which may seal the bag-forming material, leaving an open end, and the cutting mechanism may cut the bag-forming material to form individual bags. In some embodiments, the bag-forming material may be polyethylene. In some embodiments, the system further comprises a printer formed with the label applicator. In some embodiments, the system further comprises at least one of a code scanner or RFID reader. For example, the code scanner may be a bar code scanner or a QR code scanner. The RFID reader may be configured to both read RFID tags, as well as encode RFID tags.

In some embodiments, a method for forming garment transit bags comprises feeding bag-forming material in a roll feed to a label applicator, applying labels to the bag-forming material in the roll feed, sealing the bag-forming material to leave one open end of the bags, cutting the bag-forming material along opposing seals to form individual bags, and collecting the individual bags. In some embodiments, the method further comprises printing indicia on the applied labels. In some embodiments, cutting the bag-forming material comprises cutting at predetermined intervals, which may form individual bags of equal size, or may form individual bags of different sizes. In some embodiments, the method further comprises printing a code on each of the labels or applying a RFID tag to each of the labels. The method may further comprise reading information from the code or the RFID tag. In some embodiments, the method further comprises determining a location for sealing and cutting the bag-forming material based on the information read from the code or the RFID tag.

According to other embodiments, a method for forming a garment transit bag, comprises feeding a roll of bag-forming material to a label applicator, applying a label to the bag-forming material, sealing the bag-forming material leaving one open end, and cutting the bag-forming material to form a bag. The method may further comprise forming multiple bags and collecting the bags. In some embodiments, the method comprises printing indicia on the label. In some embodiments, the method comprises printing a code on the label or applying a RFID tag to the label. The method may comprise reading information from the code or the RFID tag. In some embodiments, the method comprises applying a RFID tag to the label and encoding the RFID tag. In some embodiments, the method comprises determining a location for sealing and cutting the bag-forming material based on information read from the code or the RFID tag. The information read from the code or the RFID tag may comprise size information of a garment to be placed in the bag.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary flowchart for making bags with labels;

FIG. 2 is an exemplary view of a machine used for making bags with labels;

FIG. 3 is another exemplary view of a machine used for making bags with labels; and

FIG. 4 is another exemplary view of a side sealing machine.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, and referring generally to the Figures, various exemplary embodiments of forming a transit bag with a label may be shown and described.

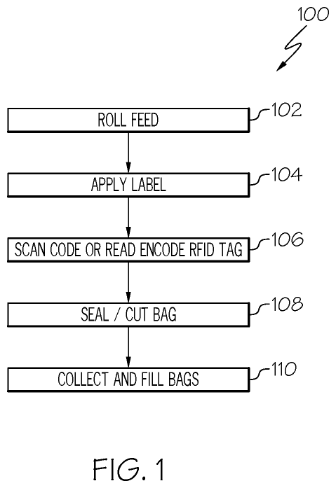

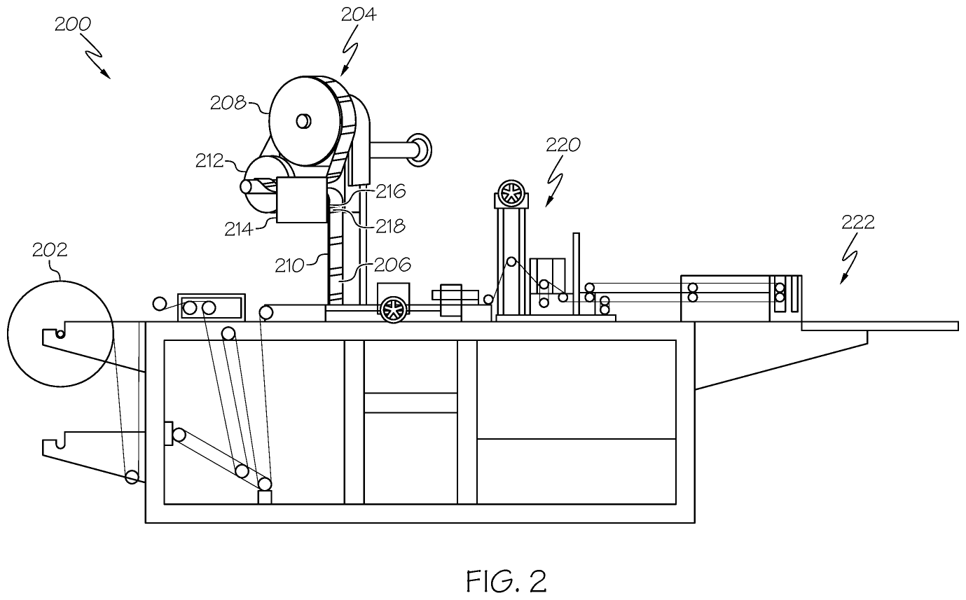

Turning now to exemplary FIG. 1, an exemplary flowchart for forming a bag is shown. The bag may be what is known as a transit bag or poly transit bag, or poly bag, although it is envisioned that other types of bags may also be formed in this manner. Further, it may be appreciated that a machine, such as the exemplary machines shown in FIGS. 2-4, may be utilized to make the bags.

Still referring to exemplary FIG. 1, a roll feed may be utilized with a roll of bag roll stock (i.e., web of poly bag material) in 102. The bag roll stock may be formed of polyethylene, or any other appropriate material, as desired. Further there may be material for any number of bags to be formed in the roll. The bag roll may be such that individual bags in the roll may have one sealed edge at regular increments along a web of poly bag material in the roll. The bag roll stock may be fed through the machine in any typical feeding manner and may be facilitated by appropriate feeding and aligning mechanisms on the machine. For example, bag roll stock may be advanced to a label applicator, as discussed further herein.

Next, in 104, a label may be applied to the bag roll stock using an applicator. The labeling of the bag roll stock may be done via pre-printed labels provided in a roll of label stock that is housed in and dispensed/applied by the applicator. However, in another exemplary embodiment, it is envisioned that the applicator may house blank label stock, which then has content printed thereon in the applicator before or after applying the labels to the bag roll stock. Such printing may be done, for example, by way of thermal transfer printing, ink jet printing, laser printing, or the like. In such an exemplary embodiment, a printer associated with the applicator may be communicatively and operatively coupled to a computer which can provide and/or receive appropriate printing commands and controls.

If bar codes or other codes are printed on the label (either pre-printed on label stock or printed by a printer associated with the applicator), the system may also use a scanner, such as a bar code or QR code reader, to read the code at 106. For example, the scanner may read a bar code to obtain the universal product code (UPC). Computing or processing means can then pass along the code, and/or any other information obtained from reading or scanning the label, to a system to retain the data. For example, the system may keep an inventory of codes that have been printed on labels.

In addition, if the label includes an RFID device, such as those available from Avery Dennison RFID Company of Glendale, Calif., then the system, (e.g., the label applicator) can include a RFID reader/writer. The RFID reader/writer may be used to read RFID tags to obtain information stored on the tag and/or to encode information on the RFID tag at 106. Such information may include, for example, electronic product codes (EPCs) associated with products to be stored in a particular bag, and other information related to products to be stored in the bag. Computing or processing means may capture and store the data associated with RFID tags in a database for retrieval at a later date.

In some embodiments, information that is read from the bar code, QR code, or RFID tag includes information related to the size of bag needed. For example, a bar code printed on a label may indicate that an extra-large shirt will be placed in the bag containing that label. As a result, the bags can be separated from one another based on the bag size so that the bags are not confused or used for the wrong products during the filling stage of the process. In addition, the system can also then control the number of bags that are to be produced for each batch based on the number of reads or scans the system collects. Advantageously, no additional bags are made for a particular size once the predetermined quantity is achieved.

Then, in 108, additional seams (i.e., sealed edges) may be formed in the bag roll stock and the bag roll stock may be cut to form individual bags. Thus, after the label is applied, any appropriate or desired additional seams may be formed in the bag roll stock, for example so that there is only one open end for the insertion of garments (or other appropriate items). The formed bags may then be collected in 108.

However, and further to 108, it may be appreciated that the bags can be cut in various sizes and shapes, as desired. For example, if a factory needs ten extra-large bags, those may be made by the machine and cut/sized appropriately. The machine can be adjusted, for example on the fly or dynamically, to shift the cutting and sizing of bags so that the next, for example, ten bags are extra-small bags. Of course, any other sized bags may be formed, and a controller associated with a cutting and sealing mechanism described with respect to 108 may be utilized to provide different dimensions or otherwise resize the bags on the machine before they are collected in 110. For example, bags may be formed in any standard or non-standard size designed to accommodate garments to be put into the bags in the most efficient manner. Variable and customizable sizing of the bags may provide many advantages: a more snug or secure storage of the garments in the bag, thus keeping garments folded during transport and maintaining the integrity of the goods; reduce the amount of bag material needed, thus reducing waste, as well as weight and shipping costs; and improve the visual appearance of the product and bag when delivered to a distribution center.

Additionally, it may be appreciated that a dynamic changing in the size of the formed bags may also be accompanied by dynamic changes to the label application in 104 such that at least some label information, such as bag size information on the label, is automatically updated based on the size of bags being formed in 108. A scanner or reader/writer can be used at step 106 to read or encode an RFID tag or scan a bar code or QR code.

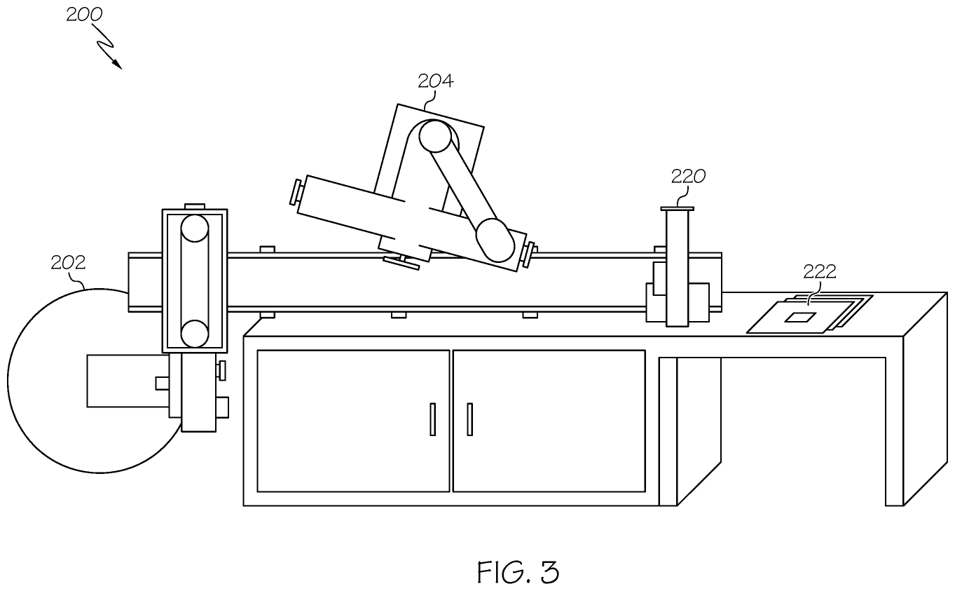

Turning now to exemplary FIGS. 2 and 3, a machine 200 that can perform the steps described with respect to FIG. 1 is shown. Machine 200 may include a variety of components which may be substantially automated in order to efficiently form bags as described with respect to FIG. 1. For example, machine 200 can accommodate bag roll stock 202, similar to that described with respect to 102 in FIG. 1. For example, bag roll stock in 202 may be formed of polyethylene, or any other appropriate material, as desired, and may be provided in a roll format. For example, bag roll stock 202 may be provided as a roll of polyethylene material wound around a central core, such as a cardboard core. Bag roll stock 202 may be in the form of a double-layer material, such as polyethylene, that is sealed along the length of one or both lateral edges (i.e., the edge of material corresponding to each edge of the roll) of bag roll stock 202. The roll of bag roll stock 202 may be held at a first end of machine 200, for example on a bar or by two pins at opposing ends of bag roll stock 202, to be fed through machine 200 in any typical feeding manner by appropriate feeding and aligning mechanisms on the machine 200.

Further, machine 200 can have label applicator 204 that applies labels 206 from label stock 208 to bags formed from bag roll stock 202. Label applicator 204 may be located downstream of bag roll stock 202 and upstream of a sealer and cutter 220, as discussed further herein. Label applicator 204 may accommodate a roll of label stock 208, to be fed through label applicator 204 in any typical feeding manner by appropriate feeding and aligning mechanisms. For example, label applicator 204 may unwind label stock 208 from a roll so that individual labels 206 may be removed therefrom and applied to bag roll stock 202. As labels 206 are removed from label stock 208, label stock backing 210 is wound by label applicator 204 onto uptake roll 212.

Label applicator 204 may have many different features that facilitate in the dynamic labeling of transit bags. For example, label applicator 204 may include a printer 214 that allows for consistent or varied content to be applied to labels 206 prior to applying them to bags. The printer 214 may be any type of suitable printer, such as a thermal transfer printer, an ink jet printer, laser printers, or any other printer appreciated by a person of ordinary skill in the art. The printer 214 may include a scanner 216 for scanning printed codes such as bar codes and QR codes. Additionally, or alternatively, printer 214 may include a RFID reader/writer 218 to read or encode RFID tags that are provided to or along with the labels. The labels 206 that are provided by the label stock 208 may have RFID tags already included with the labels 206.

Further, label applicator 204 can include computer or processing capabilities (not illustrated) that allow it to dynamically change printed content. For example, computer or processing capabilities may enable printer 214 to print information on labels 206 specific to the particular product that will be contained in the bag on which each label 206 is to be applied. For example, printed content may change when different size bags are formed, such as for use with different size garments. Any other printed content that may be included on label 206 (e.g., brand name, product type, style, color, universal product code (UPC), etc.) may likewise be varied, as determined by computer or processing capabilities. Computer or processing capabilities may also enable label applicator 204 to change the location of applied labels 206, for example, in response to a change in the size, shape, or type of bag to be formed. The computer or processing system may also be configured to capture the printed data (pre-printed on label stock 208 and/or printed on labels 206 by printer 214) and information obtained from the scanner 216 and/or RFID reader/writer 218. Computer or processing system may thus be able to determine, for example, if the correct number of labels 206 have been printed, the correct number of bags have been formed, the correct size (and number of each size) of bags have been formed, whether RFID tags included with labels 206 have been successfully encoded, and like considerations.

Still referring to exemplary FIGS. 2 and 3, machine 200 may further include sealer and cutter 220. Sealer and cutter 220 may seal the bags formed by machine 200 such that there is a single open end, which will allow garments or other products to be quickly and efficiently placed therein. In some embodiments, when bag roll stock 202 is pre-sealed along a single edge, sealer and cutter 220 seals two additional edges while leaving a fourth edge open to form an individual bag that may then be cut from bag roll stock 202. For example, when bag roll stock 202 is sealed along a single lateral edge, sealer and cutter 220 may seal two transverse edges, while leaving the opposing lateral edge open to form an individual bag. Alternatively, sealer and cutter 220 may seal one transverse edge and opposing lateral edge to leave one transverse edge open to form an individual bag. In other embodiments, when bag roll stock 202 is provided with two sealed edges (such as the lateral edges in the form of a flattened tube of material), sealer and cutter 220 seals one additional edge to form bag having one open end.

Further, sealer and cutter 220 may then cut bags to a predetermined or desired size and/or shape. As noted above, the size, shape, and even type of bags may be varied based on a variety of factors, including scheduled changes to the bag characteristics, dynamic changes to the bags based on a received command or instructions, or otherwise varied. Thus, sealer and cutter 220 may also have computer or processing capabilities (not illustrated) that allow it to receive and execute various instructions related to the sealing and cutting of bags.

Finally, machine 200 may have a bag collection device or area 222. Bag collection device or area 222 may include a receptacle, container, or any suitable compartment to collect individual bags when they are cut from the roll of bag roll stock 202 by sealer and cutter 220. Bag collection area 222 may be such that bags may be removed from machine 200 for their intended use, and may have goods, products, or garments inserted therein. Bag collection area 222 may be substantially automated or may utilize a person or robot to collect bags formed by machine 200, as desired.

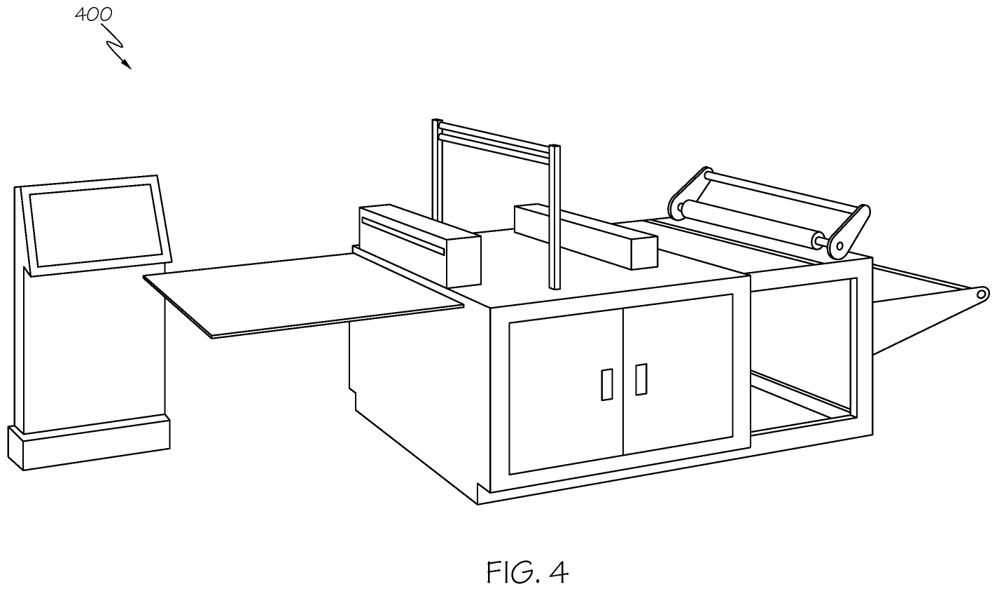

Turning now to exemplary FIG. 4, FIG. 4 shows an exemplary view of a side sealing machine 400 which may be used with or as an element of machine 200, for example to facilitate desired sealing of bags formed by machine 200. For example, side sealing machine 400 may be equipped with other functional elements, such as bag roll stock 202, label applicator 204, a sealer and cutter 220, and a collection area 222 in order to facilitate the formation of bags, such as the bags described with respect to exemplary FIG. 1.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for forming bags, comprising:
a roll feed of bag-forming material;
a label applicator;
a sealing mechanism; and
a cutting mechanism,
wherein the bag-forming material is fed to the label applicator that applies a label to the bag-forming material, the bag-forming material is then fed to the sealing mechanism that seals the bag-forming material, leaving an open end, and the cutting mechanism cuts the bag-forming material to form individual bags.

2. The system of claim 1, further comprising a printer formed with the label applicator.

3. The system of claim 1, wherein the bag-forming material is polyethylene.

4. The system of claim 1, further comprising at least one of a code scanner or RFID reader.

5. A method for forming garment transit bags, comprising:
feeding bag-forming material in a roll feed to a label applicator;
applying labels to the bag-forming material in the roll feed;
sealing the bag-forming material to leave one open end of the bags;
cutting the bag-forming material along opposing seals to form individual bags; and
collecting the individual bags.

6. The method of claim 5, further comprising printing indicia on the applied labels.

7. The method of claim 5, where cutting the bag-forming material comprises cutting at predetermined intervals.

8. The method of claim 7, where cutting the bag-forming material at predetermined intervals forms individual bags of equal size.

9. The method of claim 7, where cutting the bag-forming material at predetermined intervals forms individual bags of different sizes.

10. The method of claim 5, further comprising printing a code on each of the labels or applying a RFID tag to each of the labels.

11. The method of claim 10, further comprising reading information from the code or the RFID tag.

12. The method of claim 11, further comprising determining a location for sealing and cutting the bag-forming material based on the information read from the code or the RFID tag.

13. A method for forming a garment transit bag, comprising:
feeding a roll of bag-forming material to a label applicator;
applying a label to the bag-forming material;
sealing the bag-forming material leaving one open end; and
cutting the bag-forming material to form a bag.

14. The method of claim 13, further comprising forming multiple bags and collecting the bags.

15. The method of claim 13, further comprising printing indicia on the label.

16. The method of claim 13, further comprising printing a code on the label or applying a RFID tag to the label.

17. The method of claim 16, further comprising reading information from the code or the RFID tag.

18. The method of claim 13, further comprising applying a RFID tag to the label and encoding the RFID tag.

19. The method of claim 17, further comprising determining a location for sealing and cutting the bag-forming material based on information read from the code or the RFID tag.

20. The method of claim 19, where the information read from the code or the RFID tag comprises size information of a garment to be placed in the bag.
